(19) United States
(12) Patent Application Publication
(10) Pub. No.: US 2002/0112354 A1
(43) Pub. Date: Aug. 22, 2002

(54) Door mechanism punch-out apparatus and method

(76) Inventors: Lawrence A. Camillo, Burlington Township, NJ (US); Anthony J. Camillo, Burlington Township, NJ (US)

Correspondence Address: SAUL EWING LLP, CENTRE SQUARE WEST, 1500 MARKET STREET, 38TH FLOOR, PHILADELPHIA, PA, 19102-2186, US

(21) Appl. No.: 10/012,197

(22) Filed: Dec. 7, 2001

Related U.S. Application Data
(60) Provisional application No. 60/254,607, filed on Dec. 11, 2000.

(51) Int. Cl. B26F 1/00

(52) U.S. Cl. 30/360; 30/315; 30/358

(57) ABSTRACT

A door mechanism punch-out apparatus and method is provided for cleanly and efficiently preparing recesses in doors and door jambs to accommodate flush installation of door hardware (latches, strikes, and hinges) into doors and door jambs. The door mechanism punch-out apparatus comprises a plate, a bar, and a cutting edge. The bar is fixedly connected to the plate, perpendicularly extending from the plate in one direction. For preparing a latch face recess in a door edge, the cutting edge of the apparatus exists along the perimeter of the plate, perpendicularly extending from the plate in the same direction as the bar. For preparing a strike or hinge recess in a door jamb, the cutting edge of the apparatus exists along the perimeter of the plate, perpendicularly extending from the plate in a direction opposite that of the bar.

### FIELD OF THE INVENTION

The present invention relates generally to hand tools, and more particularly to punch-out tools for scribing (impressing) perimeter dimensions of recesses into doors and door jambs, the recesses prepared for door hardware installation.

### BACKGROUND OF THE INVENTION

Presently, two methods exist for preparing recesses in doors and door jambs for flush installation of door hardware (latches, strikes and hinges) therein. Traditionally, a door installer will mark the area to be cut (by outlining a latch face on a door edge or a strike on a door jamb), scribe the mark with a utility knife, and remove material within the scribed mark with a tool, such as a chisel, to provide a recess into which the latch face or strike is installed.

The above method has several disadvantages. First, scribing the mark with a utility knife is tedious and time consuming. Second, cutting a door or door jamb with a utility knife often results in the knife following the wood grain, causing stray and unsightly markings in the wood. Veneer doors are particularly vulnerable to stray cuts, as the veneer finish is easily damaged and the veneer texture naturally misguides attempted straight cuts. The hardness of oak or similar woods makes scribing difficult, resulting in a tedious and time-consuming process.

Alternatively, a door installer can use a router and jig assembly. The jig assembly serves as a template for the router, which prepares the recess by removing material within the template to a pre-determined depth. This procedure can also be time-consuming due to the preparation time involved. The necessity for electric, and the necessity for router operation on a horizontal plane, precludes the use of the router and jig assembly in many instances.

For the foregoing reasons, there exists a need for a simple and efficient hand tool that can quickly punch-out (scribe) precise perimeter dimensions (length, width and depth) for a recess in a door or door jamb providing flush installation of door hardware therein after material is removed within the punch-out.

### SUMMARY OF THE INVENTION

The present invention is a door mechanism punch-out apparatus and method that quickly and efficiently scribes exterior dimensions of recesses in door edges and door jambs overcoming the disadvantages of prior door hardware recess preparation.

In one aspect of the present invention, a door latch punch-out apparatus comprises a plate, a bar connected to the plate and extending in one perpendicular direction therefrom, and a cutting edge along at least a portion of the perimeter of the plate, the cutting edge extending from the plate in the same direction as the bar. The plate can be rectangular, or any shape, having dimensions matching the dimensions of any door latch face. The bar can be cylindrical and can have a diameter slightly smaller than the diameter of a typical latch hole provided in an edge of a door.

In another aspect of the present invention, the cutting edge of the plate exists along of a complete perimeter of the plate and can include a beveled tip.

In another aspect of the present invention, a door strike punch-out apparatus comprises a plate, a bar connected to the plate and extending perpendicularly in one direction therefrom, and a cutting edge along at least a portion of the perimeter of the plate and extending from the plate in a direction opposite that of the bar. The plate can be rectangular, square, or any shape, and can have dimensions matching the dimensions of any door strike. The bar can be cylindrical and can extend varying distances from the plate.

In another aspect of the present invention, the cutting edge of the door strike punch-out apparatus exists along the complete perimeter of the plate and can include a beveled tip.

In another aspect of the present invention, a door hinge punch-out apparatus comprises a plate, a bar connected to the plate and extending perpendicularly in one direction therefrom, and a cutting edge along at least a portion of the perimeter of the plate, extending from the plate in a direction opposite that of the bar. The plate can be rectangular, square, or any shape, and can have exterior dimensions matching the exterior dimensions of any door hinge. The bar can be cylindrical, or other shape, and can extend varying distances from the plate.

In another aspect of the present invention, the door hinge punch-out apparatus has a cutting edge existing along the complete perimeter of the plate. The cutting edge can have various depths to accommodate the varying depths of typical door hinges.

In another aspect of the present invention, the method for preparing a recess in a door edge for flushly installing a latch face therein comprises punching out a shape matching the shape of a latch face into the edge of the door at a depth matching a thickness of the latch face and removing material within the shape to a depth matching the thickness of the latch face. Punching out the shape in the edge of the door can be accomplished by inserting a bar of a door latch punch-out apparatus into a latch hole in the edge of the door to align a cutting edge of the door latch punch-out apparatus on the edge of the door, and impacting a bottom of a plate of the door latch punch-out apparatus to punch out the shape into the edge of the door.

In another aspect of the present invention, a method for preparing a recess in a door jamb or door edge for installing a strike or a hinge flush into the recess comprises punching out a shape matching the shape the strike or the hinge into the door jamb or the door edge at a depth matching a thickness of the strike or the hinge, and removing material within the shape to a depth matching the thickness of the strike or the hinge. Punching out in the shape in the door jamb or the door edge can be accomplished by aligning a cutting edge of a door strike punch-out apparatus, or a door hinge punch-out apparatus, on the door jamb or the door edge and impacting a bar of the door strike punch-out apparatus, or the door hinge punch-out apparatus, to punch out the shape into the door jamb or the door edge.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 illustrates a perspective view of a door latch punch-out apparatus, in accordance with the present invention;

FIG. 2 illustrates a side elevation view of the apparatus shown in FIG. 1;

FIG. 3 illustrates a top plan view of the apparatus shown in FIG. 1; FIG. 4 illustrates a cross-section view taken at the line 4-4 on FIG. 2;

FIG. 5 illustrates the door latch punch-out apparatus aligned for insertion into a latch hole in a door, in accordance with the present invention;

FIG. 6 illustrates a side elevation view of a door strike punch-out apparatus, in accordance with the present invention;

FIG. 7 illustrates a bottom plan view of the apparatus shown in FIG. 6;

FIG. 8 illustrates a cross-section taken at the line 8-8 on FIG. 6;

FIG. 9 illustrates a door with exterior dimensions of a latch face punched-out by the apparatus shown in FIG. 1, with material within the punch-out being removed with a chisel, creating a recess for installation of a door latch set therein, in accordance with the present invention;

FIG. 10 illustrates a door latch set installed within a door with latch face set flush within a recess prepared using the apparatus shown in FIG. 1; and

FIG. 11 illustrates a door jamb with a strike installed flush within a recess prepared by the apparatus shown in FIG. 6, in accordance with the present invention.

### DETAILED DESCRIPTION OF THE INVENTION

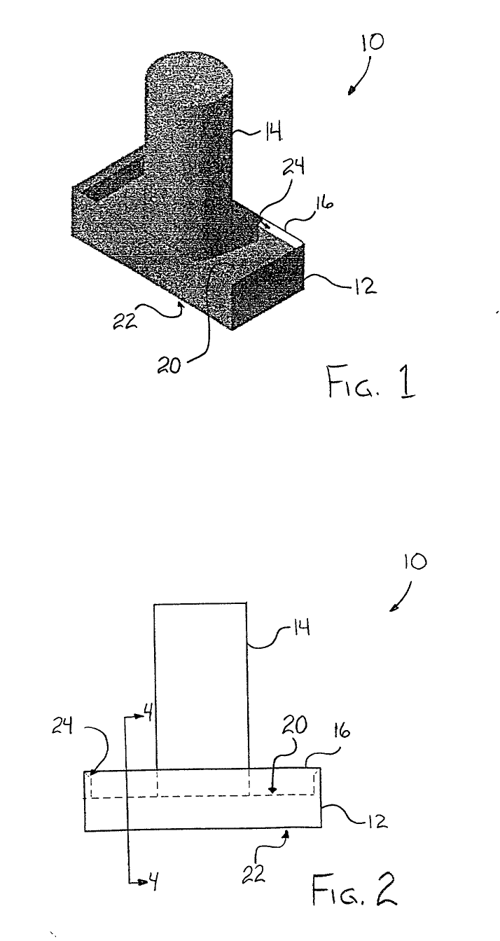

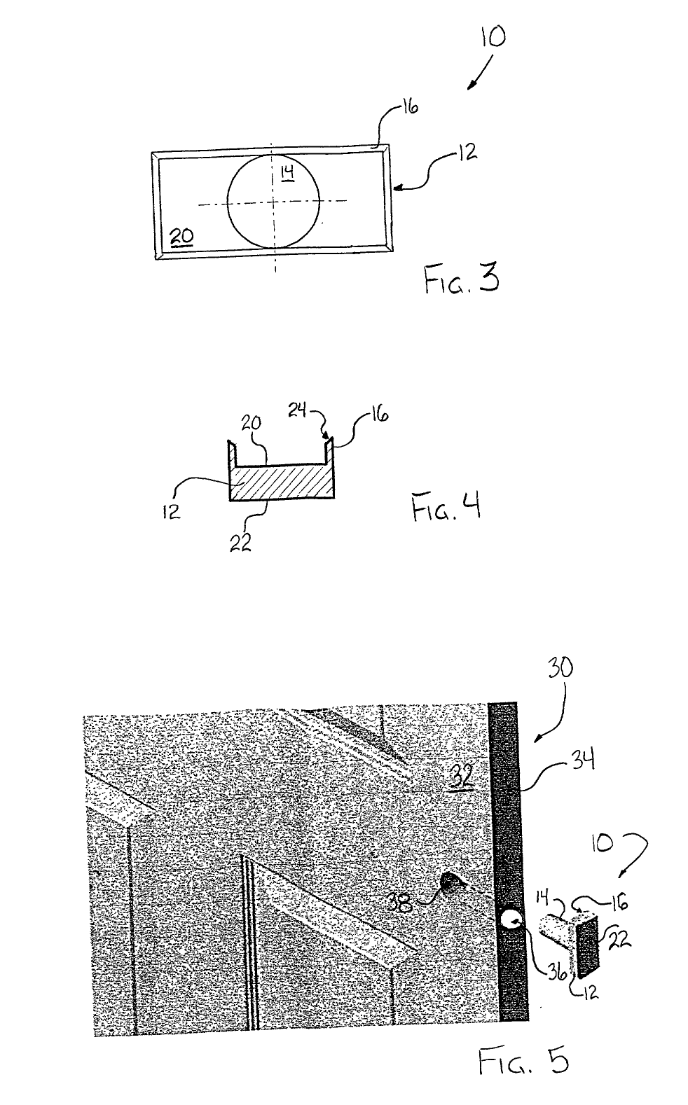

Referring now to the drawings, wherein like numerals indicate like elements, there is shown in FIGS. 1 through 4 an illustration of a door latch punch-out apparatus 10. The door latch punch-out apparatus 10 includes a plate 12, a bar 14, and a cutting edge 16. The bar 14 is cylindrically shaped and fixedly connected to the plate 12. The bar 14 is precisely centrally located on a top 20 of the plate 12, the bar 14 extending perpendicularly from the plate 12. The bar 14 can be ⅞″ in diameter and can extend 2⅛″ from a bottom 22 of the plate 12.

The plate 12 is rectangularly shaped and can have exterior dimensions of 2¼″ by 1″. A cutting edge 16 extends perpendicularly from the plate 12 in the same direction as the bar 14, the cutting edge 16 existing around the complete perimeter of the top 20 of the plate 12. The cutting edge can have a thickness of 1/16″ and can further include a 45-degree beveled tip 24. The plate 12, the bar 14 and the cutting edge 16 are made of stainless steel. The cutting edge 16 can extend ¼″ from the top 20 of the plate 12. The bar 14 can extend 1 13/16″ from the top 20 of the plate 12.

FIG. 5 illustrates the use of the door latch punch-out apparatus 10, showing a door 30 with a door face 32 having a lock set hole 38 and a door edge 34 having a latch hole 36. The door latch punch-out apparatus 10, having a bar 14 of slightly smaller diameter than the latch hole 36 diameter, is inserted into the latch hole 36. Inserting the bar 14 into the latch hole 36 precisely aligns the cutting edge 16 about the latch hole 36 so that a latch face 72 of a door latch set 70 (as shown in FIG. 10) will set flush within a recess prepared in the edge 34 of the door 30. The exterior dimensions of the plate 12, which govern the dimensions of the cutting edge 16, will be such to accommodate typical dimensions of latch faces 72 of door latch sets 70.

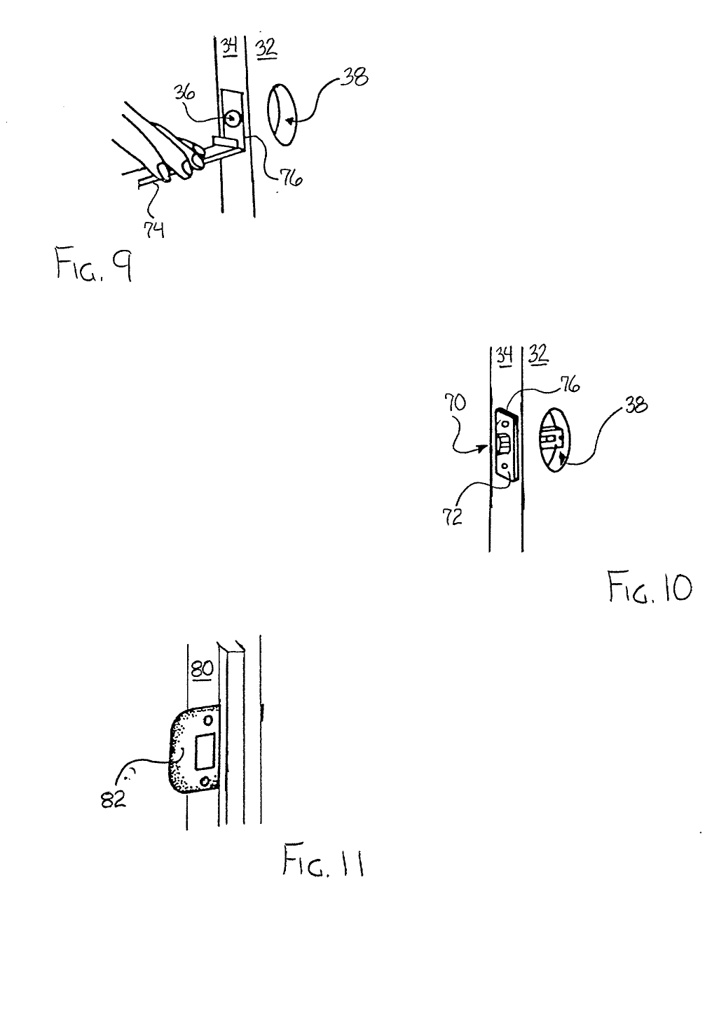

After inserting the bar 14 into the latch hole 36 and aligning the door latch punch-out apparatus 10 on the edge 34 of the door 30, the bottom 22 of the plate 12 is impacted causing the cutting edge 16 to penetrate the edge 34 of the door 30. FIG. 9 illustrates a punch-out 76 centrally positioned about the latch hole 36 in the edge 34 of the door 30. The door latch punch-out apparatus 10 facilitates swift and clean removal of material within the punch-out 76, using a tool such as a chisel 74, to create a recess having a depth equaling a thickness of a latch face 72 (due to the punch-out 76 depth created by the cutting edge 16).

FIG. 10 illustrates a latch face 72 of a door latch set 70 flushly set within the recess prepared within the punch-out 76. The door latch punch-out apparatus 10 lessens the time required to prepare a recess in a door 30 for latch set 70 installation, creating a punch-out 76 that assists in preventing unsightly marks or cuts in the edge 34 of the door 30.

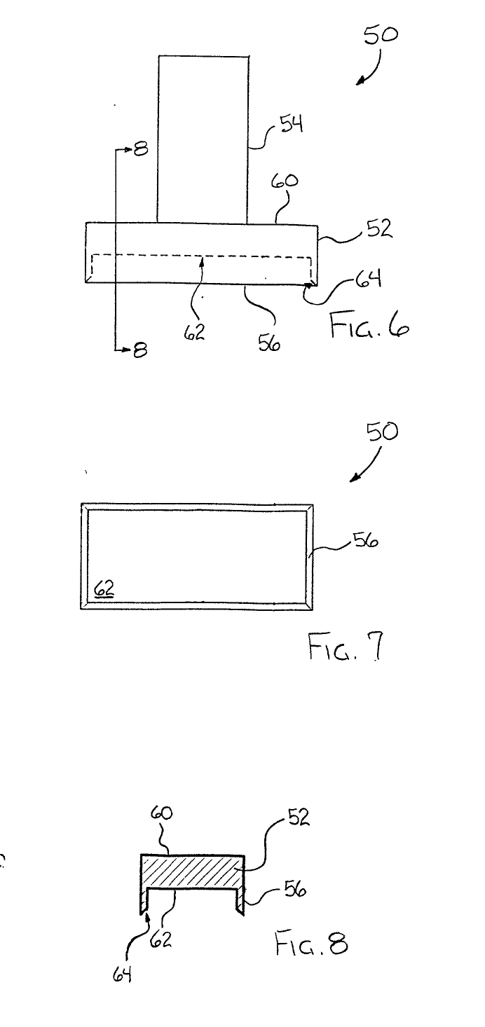

FIGS. 6 through 8 illustrate an alternative embodiment of the present invention, showing a door strike punch-out apparatus 50 including a plate 52, a bar 54 and a cutting edge 56. The characteristics and dimensions of the door strike punch-out apparatus 50 are similar to that of the door latch punch-out apparatus 10, except that the cutting edge 56 of the door strike punch-out apparatus 50 extends perpendicularly from the plate 52 in a direction opposite that of the bar 54, the cutting edge 56 extending perpendicularly away from a bottom 62 of the plate 52 with the bar 54 extending perpendicularly away from a top 60 of the plate 52. The cutting edge 56 of the door strike punch-out apparatus 50 also extends along the complete perimeter of the bottom 62 of the plate 52 (as shown in FIG. 7).

Although the particular dimensions of the door strike punch-out apparatus 50 can be similar to those of the door latch punch-out apparatus 10, it is to be understood that specific characteristics and dimensions of either apparatus 10, 50 can vary in shape, length, width, and depth of cut (cutting edge) to accommodate a variety of door hardware items, as well as a variety of dimensions for each door hardware item. For instance, a door hinge punch-out apparatus (not shown), having the same inventive concepts as those disclosed herein, could also be provided. A door hinge punch-out apparatus is provided by merely varying (enlarging) the length and width of the plate, and increasing the depth of cut (cutting edge dimension) of the door strike punch-out apparatus 50 shown in FIGS. 6 through 8.

FIG. 11 illustrates a strike 82 flushly set within a recess prepared by the door strike punch-out apparatus 50 shown in FIGS. 6 through 8. To prepare a recess in a door jamb 80 for installation of a strike 82, the cutting edge 56 of the door strike punch-out apparatus 50 is aligned on a door jamb 80; a distal end of the bar 54 is impacted with a hammer or mallet so that the cutting edge 56 penetrates the door jamb 80; wood material is removed from within the outline scribed by the cutting edge 56 to create a recess in the door jamb 80 having a depth equaling the thickness of the strike 82 (due to the punch-out depth created by the cutting edge 56); and the strike 82 is flushly set and secured within the recess in the doorjamb 80.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention.

What is claimed is:

1. A door latch punch-out apparatus, comprising:
a. a plate;
b. a bar connected to the plate and extending in one perpendicular direction from the plate; and
c. a cutting edge along at least a portion of the perimeter of the plate that extends from the plate in the same perpendicular direction as the bar.

2. The punch-out apparatus of claim 1, wherein the plate is rectangular.

3. The punch-out apparatus of claim 2, wherein the rectangular dimensions of the plate match the dimensions of a door latch face.

4. The punch-out apparatus of claim 2, wherein the rectangular dimensions of the plate are 2¼ inch by 1 inch.

5. The punch-out apparatus of claim 1, wherein the bar is cylindrical and has a diameter slightly smaller than that of a latch hole within an edge of a door.

6. The punch-out apparatus of claim 1, wherein the bar is cylindrical and has a diameter of ⅞ inch.

7. The punch-out apparatus of claim 5, wherein the bar extends 1 9/16 inch from a tip of the cutting edge of the plate.

8. The punch-out apparatus of claim 1, wherein the bar is precisely centered in relation to the plate.

9. The punch-out apparatus of claim 1, wherein the cutting edge of the plate exists along the complete perimeter of the plate.

10. The punch-out apparatus of claim 9, wherein the cutting edge of the plate extends ¼ inch from a top of the plate, providing a ¼ inch deep punch-out in a door edge.

11. The punch-out apparatus of claim 10, wherein the cutting edge of the plate is 1/16 inch thick.

12. The punch-out apparatus of claim 9, wherein the cutting edge of the plate includes a beveled tip.

13. The punch-out apparatus of claim 1, wherein the plate, the bar and the cutting edge are made of stainless steel.

14. A door strike punch-out apparatus, comprising:
a. a plate;
b. a bar connected to the plate and extending in one perpendicular direction from the plate; and
c. a cutting edge along at least a portion of the perimeter of the plate that extends from the plate in an opposite perpendicular direction from the bar.

15. The punch-out apparatus of claim 14, wherein the plate is rectangular.

16. The punch-out apparatus of claim 15, wherein the dimensions of the plate match the dimensions of a door strike.

17. The punch-out apparatus of claim 15, wherein the dimensions of the plate are 2¼ inch by 1 inch.

18. The punch-out apparatus of claim 14, wherein the bar is cylindrical and has a diameter slightly smaller than that of a latch hole in the edge of a door.

19. The punch-out apparatus of claim 14, wherein the bar is cylindrical and has a diameter of ⅞ inch.

20. The punch-out apparatus of claim 15, wherein the bar extends 1 13/16 inch from a top of the plate.

21. The punch-out apparatus of claim 14, wherein the bar is precisely centered in relation to the plate.

22. The punch-out apparatus of claim 14, wherein the cutting edge of the plate exists along the complete perimeter of the plate.

23. The punch-out apparatus of claim 22, wherein the cutting edge of the plate extends ¼ inch from a bottom of the plate, providing a ¼ inch deep punch-out in a door jamb.

24. The punch-out apparatus of claim 23, wherein the cutting edge of the plate is 1/16 inch thick.

25. The punch-out apparatus of claim 22, wherein the cutting edge of the plate includes a beveled tip.

26. The punch-out apparatus of claim 14, wherein the plate, the bar and the cutting edge are made of stainless steel.

27. A method for preparing a recess in an edge of a door for installing a latch into the door having a latch face set flush within the recess, comprising:
a. punching out a shape matching the shape of the latch face into the edge of the door at a depth matching a thickness of the latch face; and
b. removing material within the shape to a depth matching the thickness of the latch face.

28. The method of claim 27, wherein punching out the shape in the edge of the door is accomplished by:
a. inserting a bar of a door latch punch-out apparatus into a latch hole in the edge of the door to align a cutting edge of the door latch punch-out apparatus on the edge of the door; and
b. impacting a bottom of a plate of the door latch punch-out apparatus to punch-out the shape into the edge of the door.

29. A method for preparing a recess in a door jamb for installing a strike flush into the recess, comprising:
a. punching out a shape matching the shape of the strike into the door jamb at a depth matching a thickness of the strike; and
b. removing material within the shape to a depth matching the thickness of the strike.

30. The method of claim 29, wherein punching out the shape in the door jamb is accomplished by:
a. aligning a cutting edge of a door strike punch-out apparatus on the door jamb; and
b. impacting a bar of the door strike punch-out apparatus to punch-out the shape into the door jamb.

31. A method for preparing a recess in a door jamb or door edge for installing a hinge flush into the recess, comprising:
a. punching out a shape matching the shape of the hinge into the door jamb or the door edge at a depth matching a thickness of the hinge; and
b. removing material within the shape to a depth matching the thickness of the hinge.

32. The method of claim 31, wherein punching out the shape in the door jamb or the door edge is accomplished by:
a. aligning a cutting edge of a door hinge punch-out apparatus on the door jamb or the door edge; and
b. impacting a bar of the door hinge punch-out apparatus to punch-out the shape into the door jamb or the door edge.
